(19) United States
(12) Patent Application Publication
(10) Pub. No.: US 2013/0311565 A1
(43) Pub. Date: Nov. 21, 2013

(54) SYSTEMS AND METHODS FOR SHARING AND TRACKING THE PROPAGATION OF DIGITAL ASSETS

(71) Applicant: Kai Barry, New York, NY (US)

(72) Inventor: Kai Barry, New York, NY (US)

(21) Appl. No.: 13/894,560

(22) Filed: May 15, 2013

Related U.S. Application Data
(60) Provisional application No. 61/647,275, filed on May 15, 2012.

(51) Int. Cl. H04L 29/08

(52) U.S. Cl. CPC H04L 67/22
USPC 709/204

(57) ABSTRACT

Systems and methods for sharing and tracking the propagation of digital assets are disclosed. Distributors, or senders, in a distribution system can offer digital assets to recipients, resulting in a share-based relationship with each recipient. Recipients can then offer the digital asset to further recipients to become a distributor themselves, and see their own user impact on the distribution of the digital asset as well as the entire distribution web as a whole.

### CROSS-REFERENCE TO RELATED APPLICATION

This application claims the benefit of U.S. Provisional Patent Application No. 61/647,275, filed May 15, 2012, the disclosure of which is incorporated by reference herein in its entirety.

### BACKGROUND

Today there are many systems through which one can distribute digital information. Products like

Twitter and Facebook allow the user to share text and photos with family, friends, and acquaintances. But these systems don't allow the user to track the propagation of the content both back to its origin and beyond their 1^{st} degree relationships or to learn which users take action on the sent content and which users do not.

### SUMMARY

Systems and methods for sharing and tracking the propagation of digital assets are provided such that a recipient can create a share-based relationship with the sender, join the system and become a distributor themselves, and see their own user impact on the distribution of the digital asset as well as the entire distribution as a whole. For example, a user can receive content they enjoy and send that content on to new recipients. As the content continues to propagate from one user to the next, the original user, or any user in the chain, can trace and map every “hop” (shares from one user to the next) the content has taken as well as those for which they are responsible.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters refer to like parts throughout, and in which:

FIG. 1 is a diagram depicting an illustrative system for tracking the propagation of a digital asset in accordance with various embodiments;

FIG. 2 is a diagram depicting an illustrative system for tracking the propagation of a digital asset and displaying it to users in accordance with various embodiments;

FIGS. 3a-3c depict different instances of an illustrative map for displaying the geographic propagation of a digital asset in accordance with various embodiments;

FIGS. 4a-4c depict different instances of another illustrative map for displaying the geographic propagation of a digital asset in accordance with various embodiments;

FIG. 5 is an illustrative system for tracking relationships between two users in accordance with various embodiments; and

FIG. 6 is a diagram of an illustrative system for tracking the propagation of a digital asset in accordance with various embodiments;

FIG. 7 is a diagram of an illustrative system for consuming digital assets in accordance with various embodiments;

FIG. 8 depicts an illustrative user interface display for viewing digital assets that a user is currently distributing in accordance with some embodiments;

FIG. 9 is a diagram of an illustrative system for offering digital assets in accordance with some embodiments;

FIGS. 10a-10b depict illustrative user interface displays for receiving digital assets in accordance with some embodiments;

FIGS. 11a-11b depict illustrative user interface displays for distributing digital assets in accordance with some embodiments;

FIG. 12 depicts an illustrative user interface display for viewing an overall score for a digital asset in accordance with some embodiments;

FIG. 13 depicts illustrative user interface displays for creating groups for the distribution of digital assets in accordance with some embodiments;

FIG. 14 is a diagram of an illustrative system for creating a digital character in accordance with some embodiments;

FIG. 15 is a flowchart of an illustrative process for tracking the propagation of a digital asset in accordance with some embodiments;

FIG. 16 is a flowchart of an illustrative process 1600 for tracking the propagation of a digital asset in accordance with some embodiments; and

FIG. 17 is an illustrative system for distributing and tracking digital assets in accordance with various embodiments.

### DETAILED DESCRIPTION

Today, media content creators cannot easily quantify their reach or efficiently find new audiences because media is distributed under a broadcast model without a mechanism for meaningful individual feedback.

Media is currently created with specific demographic groups (e.g., 18-24 year old males, seniors 50+, or soccer moms) in mind. These demographic groups are targeted in hopes of increasing the likelihood of positive responses to a particular message or piece of media content. While targeting these groups is more efficient than sending a message to an entire population, demographic based targeting still suffers from sundry inefficiencies. For any product, many people who are not and may never be interested in the product must be contacted in order to find those who are interested. There appears to be no simple, straightforward, and precise way to know who is likely to enjoy a new piece of content.

Disclosed are systems and methods that can enable an individual user to become a media distributor. The systems and methods allow an end user to create one-to-one relationships with other users based on the media they share and to see how that media propagates through the audience from one location to the next and/or from one user to the next. It can display not only the users who received the content from the initial user, but also each subsequent hop the content takes to users who may be multiple degrees away from the initial user. In this way each user can track the digital asset's audience as well as view their own user impact on its distribution. As used herein, “user impact” can refer to any data relating to the effect a user has on a particular digital asset including, but not limited to, the downstream audience, the number of direct offers acted on positively by first-level recipients, the aggregate amount of time downstream users have been supporting the digital asset, and/or the number downstream users who are currently supporting the digital asset. Systems and methods according to some embodiments may include digital asset tracking capabilities, relationship-tracking capabilities, filtering capabilities, and audience tracking capabilities.

The systems and methods disclosed herein may additionally be useful for any number of applications beyond the distribution of digital assets. Audience tracking may allow content creators to choose the best locations to hold events (e.g., film screenings, concerts, etc.) based on how popular certain content is in particular geographic regions, or to provide quick content tests for rough cuts or works-in-progress to determine potential interest in (and audiences for) a finished product. Message tracking may allow a content creator, interest group, or other interested party to determine which members of a population are likely to be sympathetic to a particular cause or causes. Distribution statistics can help determine which users are most effective at increasing the reach of content they distribute (e.g., by number of shares, number of downstream re-shares, number of geographic locations reached, etc.).

The systems and method disclosed herein may also be used to distribute and track the distribution of physical products. For example, a link to a product available on a particular website could be shared through the system, and one could see how the product (e.g., a lawnmower or hardcover book), propagates through the system. To this end, the physical product may include a product identification code (e.g., a Quick Response (“QR”) code, a bar code, or any other suitable tracking code) that each subsequent user in the distribution chain can scan or otherwise input into the system for tracking purposes.

Generally speaking, any product identification code or hyperlink could be distributed and tracked through the system. Thus, a user could create physical media content (e.g., a flyer or poster including a QR code) or electronic media content (e.g., digital asset such as a video file, audio file, or image file embedded in a webpage) and track the downstream distribution of that content.

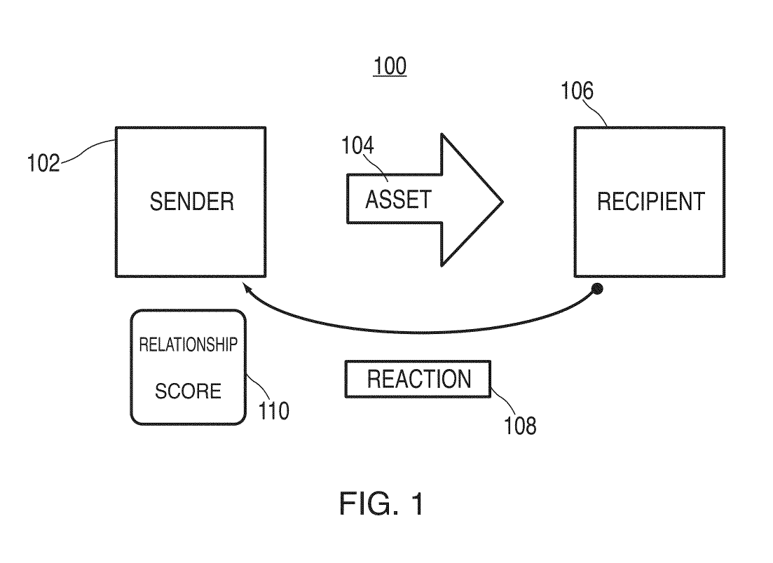

FIG. 1 is a diagram depicting an illustrative system 100 for tracking the propagation of a digital asset in accordance with various embodiments. System 100 can include a sender 102, a digital asset 104, a recipient 106, a reaction 108, and a relationship score 110. Briefly, sender 102 can offer digital asset 104 to recipient 106. The reaction 108 of recipient 106 can be tracked by system 100 and sent back to sender 102. Based on reaction 108, relationship score 110 can be adjusted accordingly.

Sender 102 can be any user of system 100 who offers content to at least one other user of system 100. As used herein, the term “offer” can refer to the act of electronically sharing a digital asset (e.g., digital asset 104) with at least one other user. Thus, sender 102 may be the original content creator (e.g., a photographer, a film maker, a musician, a songwriter, a distributor, a marketer, a writer, etc.) of digital asset 104 or a downstream recipient of content created by a content creator who subsequently offered digital asset 104 to one or more other users. In some embodiments, sender 102 may be a user with a valid, active account on system 100 or a guest user with a temporary account or no account on system 100.

Digital asset 104 can be any suitable electronic file that may be offered by sender 102 to one or more recipients 106. Thus, digital asset 104 can be media content such as a written work (e.g., an article, a book, a scholarly paper, a poem, a status update, a short message, etc.), a video file (e.g., a video clip, a music video, a full-length film, a short film, a teaser, a commercial, etc.), an audio file (e.g., a song, an album, a podcast, a lecture, a commercial, etc.), an image (e.g., a photograph, a computer-generated image, a digital reproduction of artwork, an icon, etc.), or a mixed-media file (e.g., an advertisement, promotional materials for an event, and invitation, etc.). Digital asset 104 may also be non-media content such as computer executable code. The examples listed above are not meant to be limiting; any suitable electronically sharable digital asset is contemplated as being within the scope of the embodiments disclosed herein.

Recipient 106 can be any user of system 100 who receives digital asset 104 from sender 102.

Recipient 106 may be an existing user of system 100 with a valid, active account or a guest user with a temporary account. Further, recipient 106 may be a potential user to whom sender 102 offers digital asset 104 directly (e.g., via e-mail or text message) or indirectly (e.g., via a link on a web page or via a product identification code included on a physical object).

Upon receipt of digital asset 104 from sender 102, recipient 106 can react to digital asset 104 in a number of different ways. First, recipient 106 may choose to consume digital asset 104 (e.g., by watching the video, listening to the song, reading the article, etc.) as is appropriate for the type of digital asset shared by sender 102. Second, recipient 106 may choose to re-share digital asset 104 with one or more other recipients by offering digital asset 104 to a selected individual or group. Third, recipient 106 may choose to delete digital asset 104 without offering it to another recipient. Fourth, recipient 106 may choose to ignore, or take no action with respect to digital asset 104. It should be appreciated that recipient 106 can offer, delete, or ignore digital asset 104 regardless of whether recipient 106 consumed the digital asset. Once recipient 106 reacts to digital asset 104, reaction 108 may be sent back to sender 102.

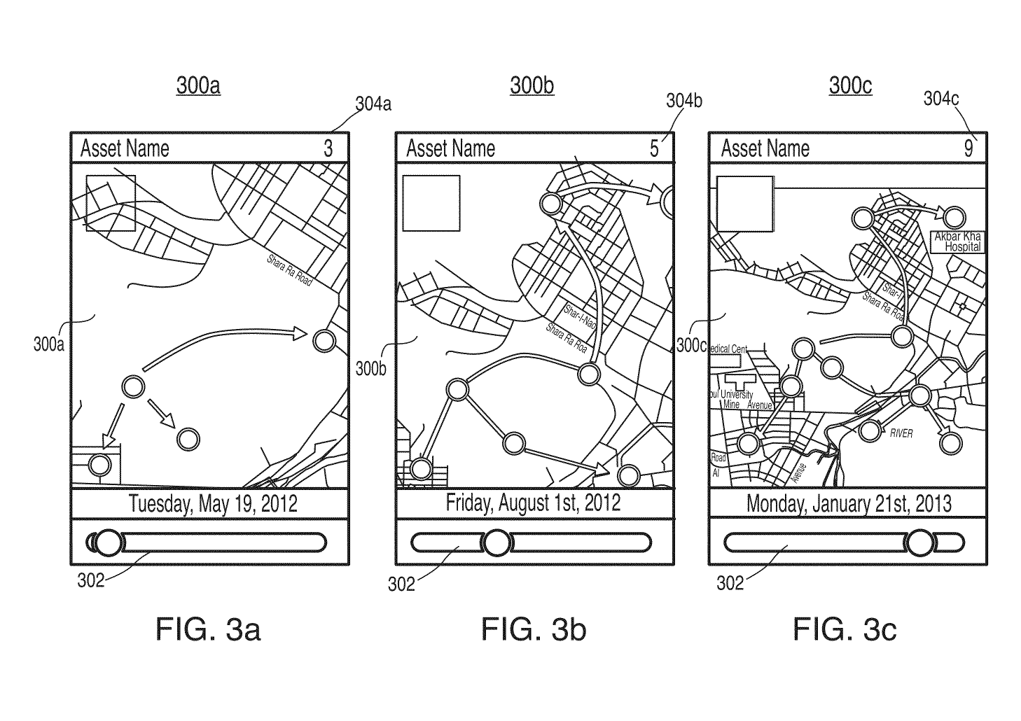

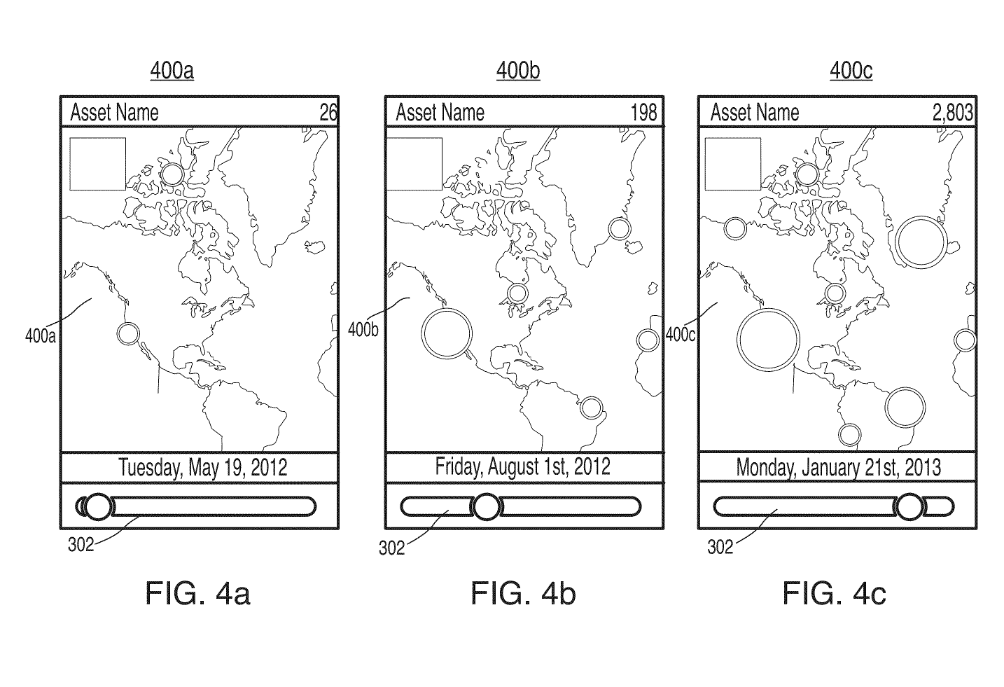

If recipient 106 offered digital asset 104 to one or more downstream users, system 100 can provide sender 102 with various suitable details relating to those offers and/or downstream users. For example, as part of reaction 108, system 100 may provide sender 102 with the names or pseudonyms, links to user profiles, and/or locations (e.g., city and state) of the individuals who received offers of digital asset 104 from recipient 106 as well as which of those downstream users offered digital asset 104 to further downstream users, and so on. The details may be presented to sender 102 in any suitable manner. In some embodiments, sender 102 may view the details in a list view. In other embodiments, sender 102 can view the details on an interactive map as discussed below with respect to FIGS. 3a-3c and 4a-4c.

According to some embodiments, detailed data regarding downstream recipients may only be available to users with a particular “status”. For instance, such data may only be made fully available to the content creator, “super users” who have achieved certain predefined goals (e.g., a certain number of offers or a certain relationship score), and/or users who have paid to receive such data as part of a subscription to system 100.

Reaction 108 can include a field indicating whether recipient 106 had a positive, negative, or neutral reaction to digital asset 104. For instance, if recipient 106 offered digital asset 104 to at least one other user, reaction 108 can indicate a positive reaction, while if recipient 106 deleted digital asset 104 or ignored digital asset 104 for a predetermined period of time, reaction 108 can indicate a negative or neutral reaction on the part of recipient 106, respectively. According to some embodiments, sender 102 may only receive reaction 108 from recipients who received the offer directly from sender 102 (e.g., recipient 106). In other embodiments, sender 102 may be entitled to view all reactions (e.g., upstream, downstream, and/or in a parallel stream) for a particular digital asset. In other embodiments, the amount of information sender 102 receives with regard to what happened to digital asset 104 can vary. Whether or not sender 102 is so entitled may be dependent on the sender's status.

Relationship score 110 may be adjusted based on reaction 108. Relationship score 110 may be a metric that tracks how well a particular recipient or group of recipients reacts to digital assets offered by sender 102. When sender 102 receives reaction 108, relationship score 110 may be incremented or decremented based on whether the reaction was positive or negative. For example, if recipient 106 offered digital asset 104 to another user, relationship score 110 may be incremented, and if recipient 106 deleted digital asset 104 without offering it to another user, relationship score 110 may be decremented. System 100 may also calculate one or more composite relationship scores, which may be referred to generally as “sender scores,” representing weighted and/or unweighted totals of all or a subset of a user's relationship scores.

According to various embodiments, when a recipient ignores an offered digital asset, relationship score 110 may remain unchanged or be decremented. Recipient 106 may also be given the option to choose (actively or using default settings) whether or not to decrement a relationship score with a sender when an offered digital asset is ignored. As described below, relationship score 110 may be used to determine whether or not the sender is permitted to send further offers to a particular recipient. For example, if relationship score 110 falls below a threshold value, system 100 may prohibit sender 102 from offering any further digital assets to recipient 106. As another example, if one or more of a user's sender scores falls below a threshold value, system 100 may prohibit sender 102 from offering digital assets to all users of system 100.

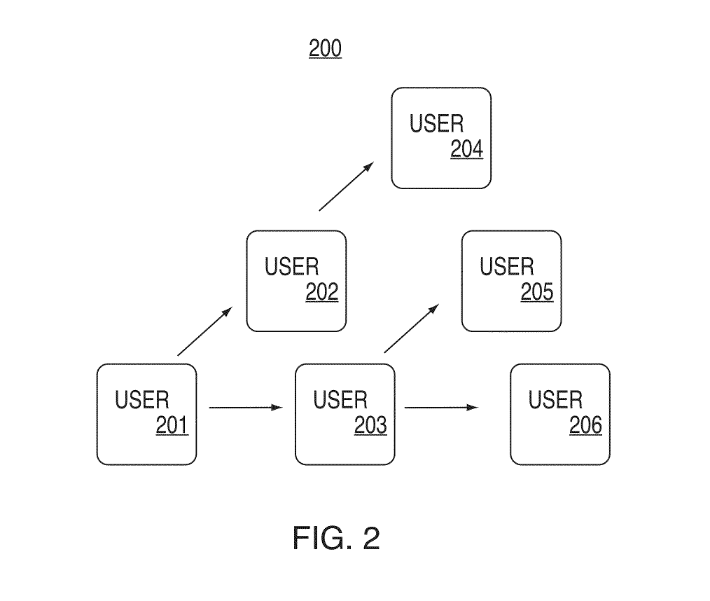

FIG. 2 is a diagram depicting an illustrative distribution web 200 for tracking the propagation of a digital asset and displaying it to users in accordance with various embodiments. As used herein, a “distribution web” may refer to a dataset compiling the full audience for a digital asset, or a subset of the full audience, including at least a variable that tracks how the digital asset propagated from user to user. For instance, distribution web 200 may keep track each user in the audience as well as which users offered the digital asset to which recipients.

User 201 may be the content creator for the digital asset or a downstream recipient of content created by a content creator. As used herein, the term “content creator” may refer to the user (e.g., the photographer, film maker, musical artist, distributor, marketer, or writer) responsible for originally offering the digital asset to other users via the distribution system. As shown in FIG. 2, User 201 offered the digital asset to User 202 and User 203. Subsequently, User 202 offered the digital asset to User 204, and User 203 offered the digital asset to User 205 and User 206. While only six users are depicted in distribution web 200, it should be appreciated that a distribution web may include any number of users.

According to some embodiments, the distribution system can track user data each hop of the digital asset. Various data about each user in the distribution web may be tracked including, for example, the user's name or pseudonym, the user's physical location, and whether and to whom the user offered the digital asset. In some embodiments, all users in the distribution web or all users of the distribution system may be privy to all or a subset of the tracking information. In other embodiments, tracking information may only be made available to users with a certain status such as, for example, the content creator, a paid subscriber to the distribution system, or a super user. In still further embodiments, some tracking data (e.g., users' locations) may be available to all users while other tracking data (e.g., users' names or pseudonyms) may be restricted according to users' status.

FIGS. 3a-3c depict illustrative distribution maps 300a-300c, respectively, for displaying the geographic propagation of a digital asset in accordance with various embodiments. Distribution maps 300a-300c may be used for digital asset tracking, which can provide the content creator, as well as every member of a distribution web (e.g., distribution web 200 of FIG. 2) with access to the tracking data, the ability to see each and every location a digital asset has traveled to as well as the path(s) it took to get there. Distribution maps 300a-300c may be created by geographically stamping the location of each hop, tracking which user offered the digital asset, and which user received it. Thus, a system in accordance with some embodiments can track and display to the user the digital asset's journey through space and time, and from one user to the next. In some embodiments, distribution maps 300a-300c may also display the makeup and propagation of the total audience or just the portion of the audience for which the user is responsible.

Distribution maps 300a-300c may provide detail regarding the digital asset's audience. For instance, downstream users who acted on the digital asset may be represented by a dot on the map. In some embodiments, a slider 302 at the bottom of the page can permit the user to watch the distribution of the digital asset to an audience (e.g., the user's downstream audience or the entire audience) over time. In some embodiments, a user's downstream audience may be displayed differently (e.g., in a different color, highlighting scheme, or shape) than users not in the user's downstream audience.

For example, downstream users may be represented by blue dots while upstream users and users on different distribution paths may be represented by red dots.

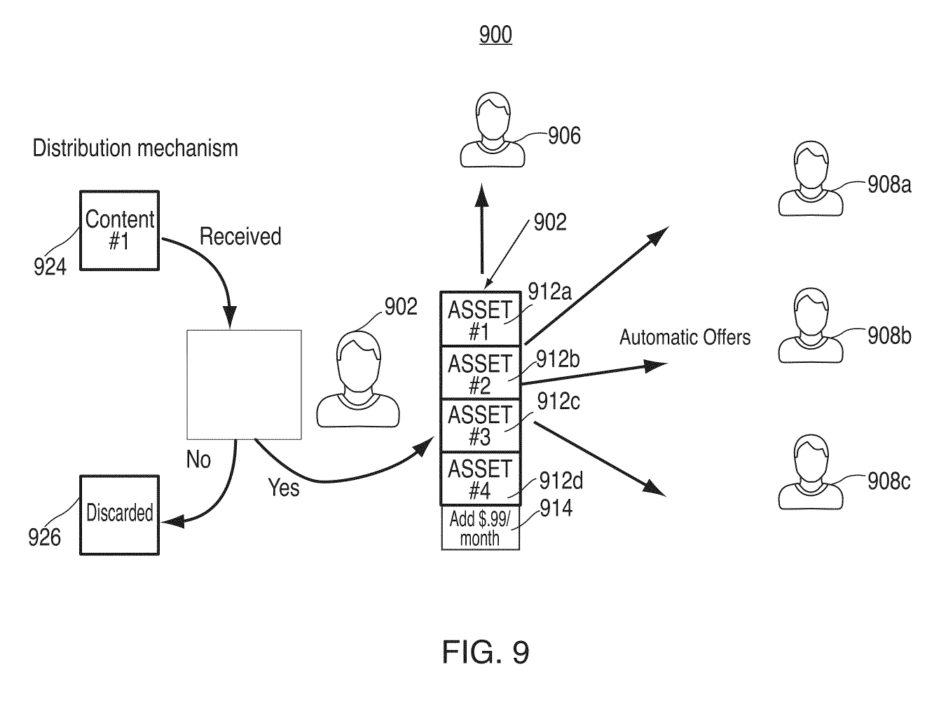

In some further embodiments, distribution maps 300a-300c may display only those users who are currently supporting the digital asset (e.g., offering the digital asset to one or more other users via a distribution list (e.g., distribution list 910 of FIG. 9, below). The user may be permitted to switch between views of all downstream users and downstream users who are currently supporting the digital asset. In other embodiments, downstream users and downstream users who are currently supporting the digital asset may be displayed simultaneously, but differently (e.g., in a different color, highlighting scheme, or shape).

Distribution maps 300a-300c may also include a running total of a user's audience (e.g., running audience scores 304a-304c). This running total may also be in sync with the slider, allowing the user to see how the portion of the audience for which they're responsible grew over time.

In accordance with additional embodiments, a distribution map may include lines drawn between each sender/recipient pair in the distribution network. These lines may be displayed in any suitable manner. For example, if the user taps on any dot on the map a line can be drawn through every share back to the origin of the content. Alternatively, a line may be drawn between each sender/recipient pair in the distribution network or between each sender/recipient pair that the user is responsible for (e.g., downstream of the user).

Depending on the zoom level of the distribution map, different levels of detail about each user in the distribution web for a particular digital asset may be displayed. At very close zoom levels, such as the zoom level shown in distribution maps 300a-300c, detailed information about individual users, including their name or pseudonym, a link to their user profile, and/or information regarding whom that user received the digital asset offer from and to whom that user offered the digital asset may be displayed.

FIGS. 4a-4c depict illustrative maps 400a-400c, respectively, for displaying the geographic propagation of a digital asset at relatively distant zoom levels in accordance with various embodiments. At relatively distant zoom levels (e.g., on the scale of a country) very generic information may be displayed on distribution maps 400a-400c. For example, distribution maps 400a-400c may only display the number of users who received offers for the digital asset in a broad geographic area (e.g., a city or state) and/or graphical representations of the number of users who received offers in each geographic area, which can vary in size based on the number of users. At relatively closer zoom levels (e.g., on the scale of a state) more detailed information, such as the number of users who received offers for the digital asset in each county or town may be displayed on a distribution map.

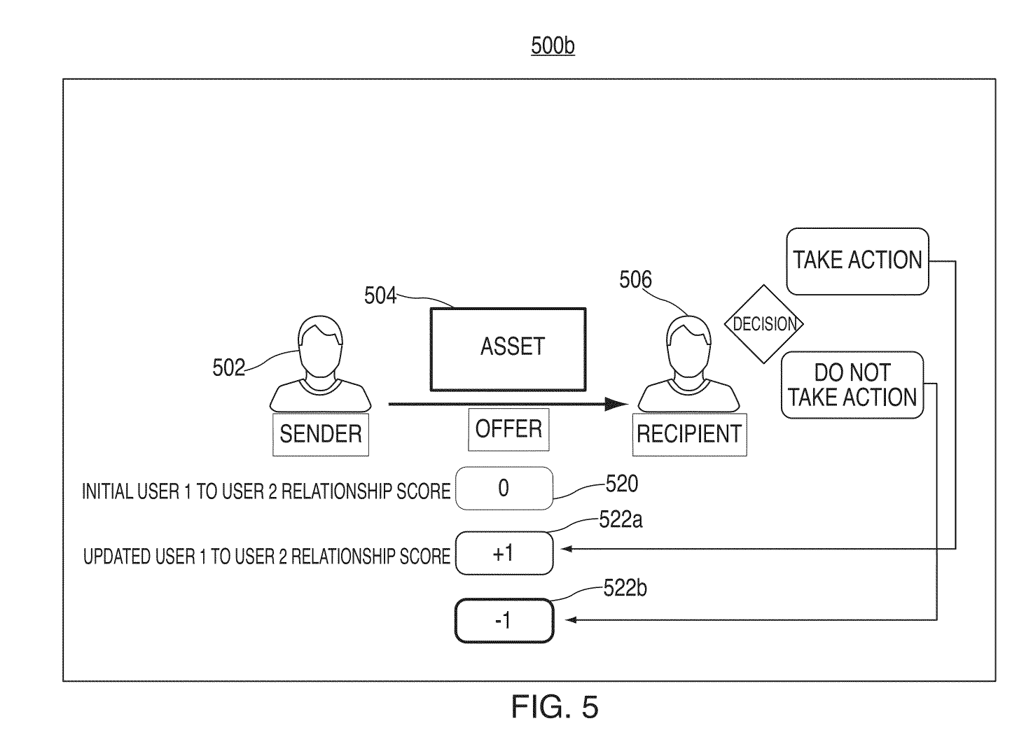

FIG. 5 is diagram depicting an illustrative system 500 for tracking relationships between two users in accordance with various embodiments. System 500 may track the status of relationships between individual users where each user-to-user relationship is updated based on whether the recipient reacts to the offered digital asset and, if so, what type of action the recipient takes. This tracking can create a feedback loop and result in an ever-changing “live” relationship score. In other words, every sender (e.g., sender 502) can have a scored relationship with every recipient (e.g., recipient 506). This relationship score may be based on how the recipient responded to the previous offers the sender sent to the recipient. For example, the system can determine whether the recipient acted upon the digital asset received from the sender (e.g., by consuming the digital asset, purchasing the digital asset, offering the digital asset to another user, etc.).

As one example, each time the recipient takes a positive action the relationship score can be incremented, and each time the user does not take action or reacts negatively (e.g., by deleting the digital asset) the score can be decremented. In another example, the relationship score can include two separate scores, which can track positive and negative reactions separately. It should be understood that other suitable methods for tracking relationship scores between users might be possible without straying from the spirit of the disclosed embodiments.

As depicted in FIG. 5, sender 502 can have an initial relationship score 520 of 0 with recipient 506. Subsequently, sender 502 can offer digital asset 504 to recipient 506 and, in response, recipient 406 can choose to take action or not with respect to digital asset 504. If recipient 506 takes some positive action with respect to digital asset 504, relationship score 522 can be incremented 522a accordingly. However, if recipient 506 does not take action with respect to digital asset 504 or takes negative action, relationship score 522 can be decremented 522b.

Recipient 506 may have the choice to refrain from decrementing relationship score 522. For example, recipient 506 may wish to continue to receive offers from sender 502 even if the latest offer from sender 502 was treated negatively or ignored. Accordingly, recipient 506 may be given the option to decrement or leave unchanged relationship score 522 if no action or a negative action is taken with respect to offer 504. Recipient 506 may also, for example, set default options to only decrement relationship score 522 if negative action is taken with respect to digital asset 504 and to leave relationship score 522 unchanged if digital asset 504 is ignored.

According to some embodiments, incoming offers may be filtered based on the current relationship score between two users. For example, a user can set a relationship score threshold to filter incoming offers based on their relationship score with any sender. This filter can allow each user to determine the required relationship quality for permitting other users to communicate with them. In one particular example, a user could set their relationship score filter to ‘−2,’ such that senders may only send offers to the user if they have a ‘−2’ score or higher with the user.

Using relationship scores and filtering, a sender unknown to the recipient may be permitted to send unsolicited offers. However, if the recipient does not take action or takes negative action (e.g., by deleting the offer) the received media the relationship score with that unknown sender can be decremented. When the relationship score falls below the filter threshold the sender may be prohibited from sending the recipient additional offers.

In some embodiments, users can track their own user impact on the audience for a particular digital asset. For example, each user may have a running audience score. The running audience score may track the total number of downstream users who have received content that user has distributed. Thus, in the embodiment depicted in FIG. 2, User 201 may have a running audience score of 5, representing Users 202-206 who received offers downstream of User 201. As more downstream users offer the digital asset, User 201's running audience score can increase appropriately.

As the digital asset offered by User 1 makes more and more hops, however, less of the audience may be attributable to User 1. Accordingly, the running audience score may only represent downstream users within a certain number of hops away from User 1 (e.g., 3 hops). In other embodiments, the running relationship score may be incremented to a lesser degree for each subsequent hop away from User 1. For example, User 1 may receive full credit for first-level recipients, Users 2 and 3 (e.g., an increment of 1 in the running audience score), and less credit for second-level recipients, Users 4-6 (e.g., an increment of 0.75 in the running audience score).

Such attenuation in the running audience score for a particular user may be calculated according to any suitable function (e.g., a linear or exponentially decreasing function).

In some embodiments, the running audience score can rise and fall as a digital asset becomes more popular or inactive, respectively. For instance, if a particular digital asset is offered a certain number of times in a distribution web the user's running audience score may be multiplied by a predetermined factor. In one example, if a digital asset is offered 1,000 times the running audience score for a user who is a sender in the distribution web may be multiplied by a factor of 1.1×. Thus, as the total audience for a particular digital asset increases (indicating that the digital asset is popular), the running audience score can reflect that increase above and beyond the raw number of user's running audience score. On the other hand, if the total for the audience for a digital asset is decreasing or the pace of increase in the total audience size is diminishing, the running audience score may be reduced by a certain factor (e.g., multiplied by a factor of 0.9×).

According to some embodiments, if the running audience score surpasses certain threshold levels, new features and tools may become available to the user. In this way, top distributors may be given more powerful tools with which to manage their audience.

In some additional embodiments, the system may include tools for communicating with users who have acted upon a particular media item. For example, once an audience for a particular digital asset has been defined through the propagation process, this same audience can be readdressed with additional content or messaging. Extra content may include, for example, extra features related to the media item, advertisements, and/or messaging from the digital asset's content creator.

Once the audience for a particular digital asset has been established (e.g., the digital asset has propagated through the population and identified those interested parties who have offered the digital asset to someone new) this audience can then be tapped or re-tapped in a number of ways. In some embodiments, a user may be permitted to send a “blast distribution” to the entire established audience. For example, the content creator, or any other user with appropriate permission, which may be based on the user's status, for example, may be permitted to send messages or additional content to everyone in the established audience at once. In these embodiments, the user may be permitted to directly access the established audience (e.g., for a fee), thus providing a marketplace in which the user could communicate with the established audience and/or sell the right to do so. In other embodiments, some or all members of the established audience may be permitted to unlock new piggyback content. This piggyback content could be enhanced content (e.g., like extras on a DVD), special offers (e.g., coupons), and/or first access to new content.

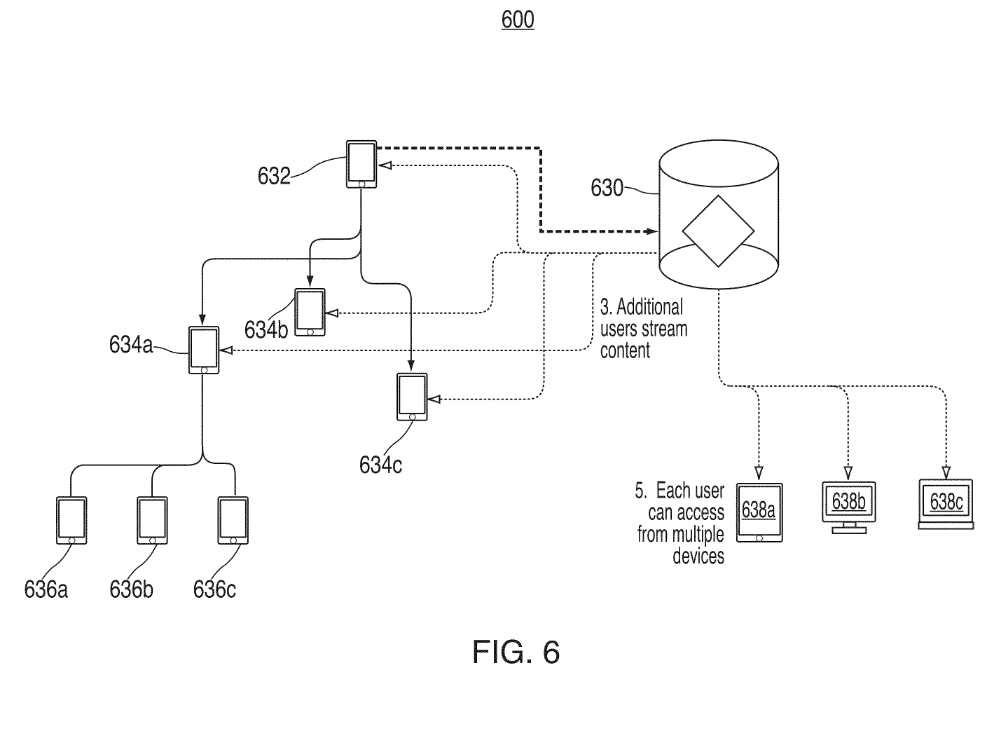

FIG. 6 is a diagram of an illustrative system 600 for distributing an electronic digital asset in accordance with various embodiments. In particular, system 600 can include one or more content servers 630 (only one server 630 is shown in FIG. 6, but persons of ordinary skill in the art will appreciate that additional servers may or may not be utilized), content creator 632, recipients 634a-634c, recipients 636a-636c, and electronic devices 638a-638c. System 600 may be a cloud-computing based system with client software installed on mobile, desktop, and home computing devices and a cloud service running on servers.

Content server 630 can be a computer or set of computers that include server-side software and/or hardware that can store content (e.g., digital assets such as video files, audio files, written works, etc.) and keep track of data required for operation of system 600 including, for example, user accounts data, user relationship data, and/or business logic.

Client-side software may be installed on any suitable electronic device such as, for example, a mobile device 638a, a television 638b, a personal computer

(“PC”) 638c, or any other suitable electronic device, and the user interface of the client software may vary depending on the type of client device. A particular user may access content servers 630 using any one of electronic devices 638a-638c, or any other suitable electronic device, installed with client-side software for communicating within system 600.

Content creator 632 can create a digital asset for use in system 600 by uploading the digital asset to content servers 630. At that time, access to the digital asset may be restricted to content creator 632. Specifically, content creator 632 may be permitted to download, access, view, and/or stream the digital asset onto any one of electronic devices 638a-638c with access to system 600 via the user account of content creator 632. Content creator 632 may also be permitted to offer the digital asset to one or more other users of system 600. As depicted in FIG. 6, the one or more users who receive an offer of the digital asset from content creator 632 can include recipients 634a-634c.

Upon receipt of the offer from content creator 632, recipients 634a-634c may be granted access to the digital asset on content servers 630. Recipients 634a-634c may then be permitted to download, access, view, and/or stream the digital asset onto any one of electronic devices 638a-638c with access to system 600 via the respective user accounts of content creator 634a-634c. In turn, recipients 634a-634c may be permitted to offer the digital asset to one or more second-level recipients 636a-636c, and so on, ad infinitum. In some embodiments, content creator 632 may retain some level of proprietary control over the digital asset and may, for example, delete the digital asset from content servers 630, set an automatic expiration date for the digital asset after which no other users can access the digital asset, and/or limit the total number of users who may access the digital asset. Further, content creator 632 may limit how downstream recipients (e.g., recipients 634a-634c and second-level recipients 636a-636c) may access the digital asset. As one example, content creator 632 may allow the digital asset to be streamed but not downloaded to a recipient's client device. In some embodiments, a user may also be given the opportunity to comment on the content.

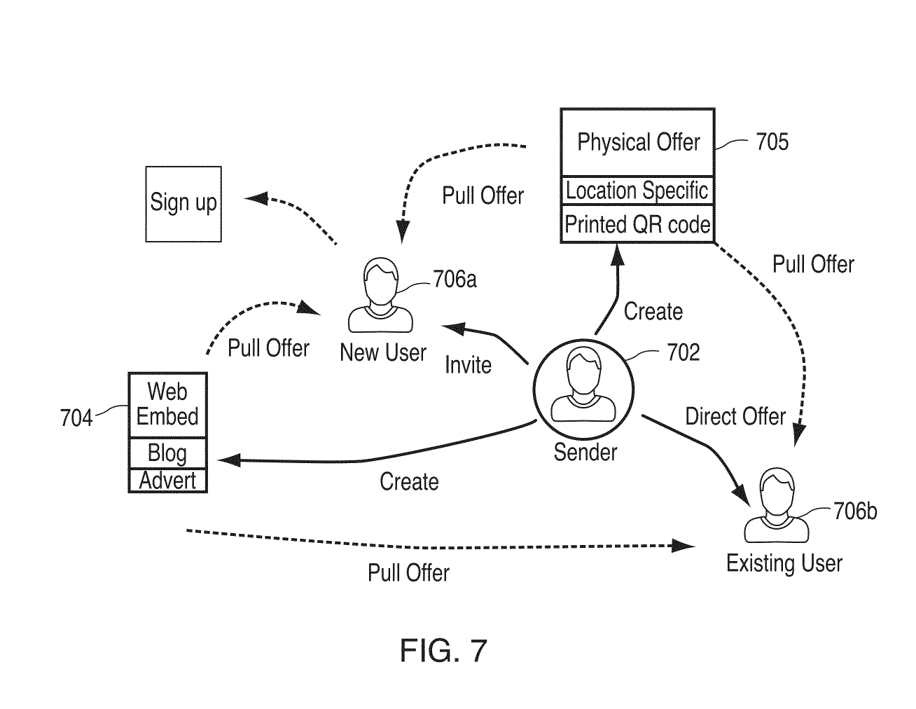

FIG. 7 is a diagram of an illustrative system 700 for offering digital assets in accordance with some embodiments. Besides distributing digital asset offers directly to existing users of a distribution system (e.g., system 600) using a client-side interface, a sender 702 may distribute “public offers,” which may be offers made to the public at large who may or may not be users of the distribution system. As used herein, the term “pull” can refer to a user accepting a public offer. Advantageously, public offers may allow a user to track where, in physical space and/or in virtual space, the offer is most favorably received.

Public offers (e.g., electronic public offer 704 or physical public offer 705) may be user-specific. That is, the product identification code may identify the user responsible for creating the public offer in addition to identifying the offer itself. For example, a user with suitable access to a particular digital asset may print out a flyer, sticker, or other suitable physical embodiment of an offer for that digital asset that includes a product identification code. When new user 706a or existing user 706b receives physical public offer 705 (e.g., by scanning or otherwise using the product identification code to access the offer), the user who created the public offer, who may or may not be the content creator, may be identified as the sender of the public offer. Accordingly, the user who created the public offer may establish a sender-recipient relationship with each user who pulls the public offer.

According to some embodiments, sender 702 may create an electronic public offer 704 embedded in an

Internet website (e.g., as a hyperlink on a blog or advertisement), e-mail, status update, Tweet, or any other suitable electronic communications medium. A new user 706a (i.e., a person without a valid user account for the distribution system) can pull electronic public offer 704 and be directed to a sign-up portal for the distribution system. New user 706a can sign up and become a member of the system in order to actually accept and act on the offer by consuming and/or re-offering the digital asset to other users, for example. An existing user 706b may pull electronic public offer 704 and be prompted to log into their user account and/or to act on the offer.

Electronic public offer 704 may also be made available automatically to users in a pre-defined geographical area. For example, if a user's electronic device is equipped with a Global Positioning System (“GPS”) receiver, sender 702 may make electronic public offer 704 available to users within a specified area. Sender 702 may also make electronic public off 704 available to users connected to a particular network access point (e.g., a Wi-Fi hotspot). As one particular example, users attending a musical performance in Central Park may receive one or more electronic public offers 704 from the performing artist. The offers may include, for example, audio tracks or samples, messages from the artist, music videos, or any other suitable digital asset related to the artist.

Sender 702 may also create a physical public offer 705. Physical public offer may be accessible by new user 706a or existing user 706b via a product identification code placed on a physical object. In some embodiments, the physical object can be a flyer, and the product identification code can be a QR code. In such embodiments, a user (e.g., new user 706a or existing user 706b) can scan the QR code and act on physical public offer 705 as described above with respect to electronic public offer 704. As one particular example, physical public offer 705 may be printed on a flyer advertising a new film. When new user 706a or existing user 706b scans the QR code printed on the flyer with an electronic device, the distribution system can provide the user with access to a digital asset associated with the offer, which may be, for example, a trailer for the film.

As with electronic public offer 704, physical public offer 705 may also be location specific. For example, a product identification code may be provided on a stationary object (e.g., on a plaque attached to or nearby a tourist attraction). New user 706a and/or existing user 706b may scan or otherwise access the product identification code to receive the location specific physical public offer 705. In some embodiments, location specific offers may be restricted such that recipients cannot offer the digital asset associated with the offer to other users who are not physically present at the required location.

As described above, sender 702, who may be the content creator or any other existing user, may also directly offer a digital asset to existing user 706b.

Similarly, sender 702 may directly invite new user 706a to join the distribution system with or without concurrently sending new user 706a an offer.

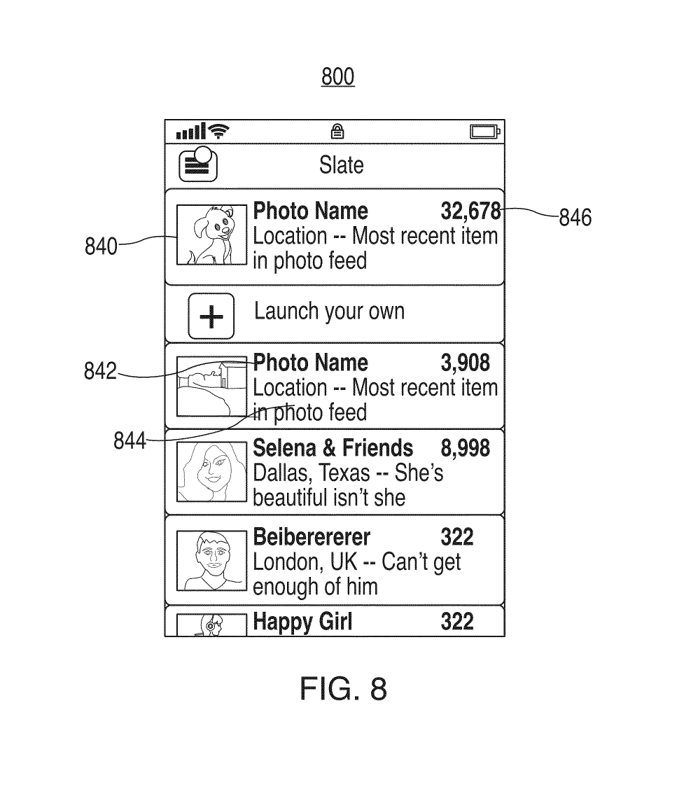

FIG. 8 depicts illustrative a user interface 800 for viewing digital assets that a user is currently distributing in accordance with some embodiments. Such user interfaces may be referred to herein as “slates.” Digital assets that the user offers to one or more other users may be automatically moved to their slate. The slate may present the user with data about each offered digital asset, including audience-tracking data. As depicted in FIG. 8, if the user is offering image digital assets, a thumbnail 840 of each image may be displayed along with the image name 842, the location 844 the image was acquired or created, and the total audience for the image. In some embodiments, the slate may only display the digital assets that the user is currently supporting. When the user no longer wants to distribute the digital asset, it may be automatically removed from the slate.

The digital assets presented on a user's slate may be prioritized on the display using any suitable characteristics. For example, as the content reaches a larger and larger audience it can parade up the screen achieving new threshold goals as it goes. The digital asset that reaches the largest audience, for example as defined by the user's running audience score 846 for that digital asset, can be held at the top of the screen as a “high score.” In some embodiments, a user may be permitted to rearrange and/or delete content from the slate (e.g., if the user thinks the content has reached its maximum audience). In other embodiments, digital assets may be presented on the slate in order from the most to least recently offered digital asset or in any other suitable order.

FIG. 9 depicts a diagram of an illustrative system 900 for offering digital assets in accordance with some embodiments. User 902 may maintain a distribution list 910, which can include digital assets 912a-912d that the user is currently distributing to other users.

User 902 can offer one or more of digital assets 912a-912d in distribution list 910 to recipient 906, which may be an individual user or a group of users, as described above. Digital assets 912a-912d may be digital assets that user 902 created and/or uploaded to the system, in which case user 902 may be considered the content creator. However, digital assets 912a-912d may also include digital assets received from other users (e.g., received digital asset 924). If user 902 chooses not to add newly-received digital asset 924 to distribution list 910, received digital asset 924 can instead be converted to discarded digital asset 926.

In some embodiments, user 902 may also have a list of followers 908a-908c to whom offers are automatically generated from user 902.

Followers 908a-908c may be, for example, other users who have enjoyed content offered by user 902 in the past. When user 902 adds a new digital asset to distribution list 910, therefore, each of followers 908a-908c can automatically receive an offer for that digital asset. User 902 may be given access to the identities (e.g., names, pseudonyms, user profiles, etc.) of followers 908a-908c in order to provide targeted digital asset distribution, marketing, and/or advertising to a group that is known to be interested in digital assets offered by user 902. User 902 may also have some proprietary control over followers 908a-908c such that once an individual relationship score between user 902 and a particular follower falls below a certain threshold, that follower may be prohibited from following user 902.

In some embodiments, user 902 may have a limited number of “slots” in distribution list 910. For example, a typical user may be allotted four slots in distribution list 910 for offering digital assets to other users. Limiting the number of slots in distribution list 910 may help to keep content distributed through the system fresh and ever changing. However, distribution list 910 can also include subscription option 914. Subscription option 914 may allow user 902 to add additional slots to distribution list 910. For example, user 902 may be prompted to pay a fee (e.g., a monthly subscription fee, a one-time fee, a per diem fee, or any other suitable fee) in order to support additional slots in distribution list 910. It should be understood that user 902 may have any suitable number of slots (e.g., 0-100) in distribution list 910, and the total number of slots may be capped, regardless of whether user 902 wishes to pay a subscription fee for additional slots. Further, the number of free spots in distribution list 910 may vary according to the status of user 902 (e.g., whether user 902 pays a subscription fee, has achieved certain goals, etc.). In some embodiments, for example, user 902 may not have any free slots and must, therefore, pay for each spot in distribution list 910.

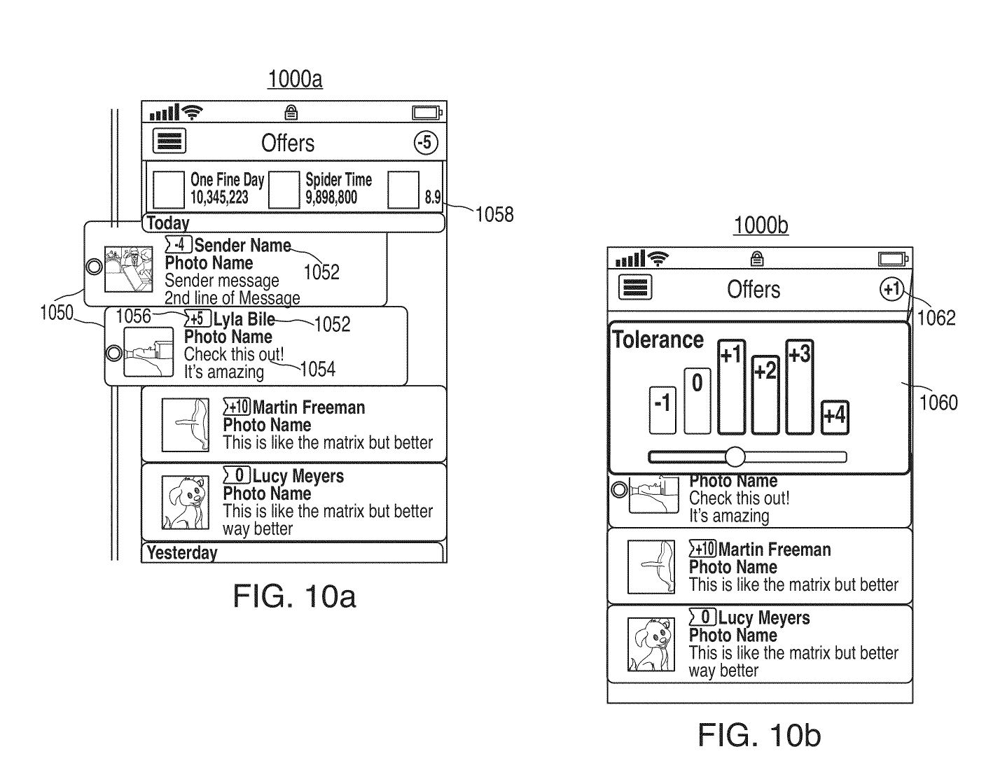

FIG. 10a depicts an illustrative user interface 1000a for receiving digital asset offers in accordance with some embodiments. User interface 1000a may be referred to herein as an “offer screen,” which may function like a traditional email inbox with a few differences. New offers 1050 (e.g., digital assets offered directly or indirectly to the user) may appear on the offer screen when the offer received. A user may, according to some embodiments, be required to act upon the offer (e.g., by consuming, re-offering, and/or deleting the offer) before being allowed to act upon any subsequently-received offers. In some embodiments, new offers may animate in from the left.

New offers can arrive along with various data, including the sender's name 1052 and pitch message 1054, as well as a relationship score 1056 the sender currently has with the user. The user can choose to see details about the digital asset (e.g., by making a tapping gesture on the offer), delete the offer (e.g., by making a swiping gesture to the left), or send it on to other users who the recipient thinks will enjoy it (e.g., by making swiping gesture to the right). In should be appreciated that such gestures are merely exemplary, and other suitable gestures may be defined by the client software and/or by a user of the client software. As one other particular example, a user may tap on an offer on their offer screen and be presented with a menu listing options to consume, delete, and/or re-offer the offer. In should be appreciated that the use of gestures, which may be suitable for some electronic devices (e.g., smartphones), may not be suitable for others (e.g., PCs). Still further, suitable voice commands and/or gestures may be used in conjunction with wearable computers equipped with one or more head mounted displays (“HMDs”).

In some embodiments, a ticker 1058 may also be included on user interface 1000a, or any other suitable user interface, which can display the most popular digital assets being distributed in the network.

Ticker 1058 may be displayed at the top of user interface 1000a, for example. A user may be permitted to pull such offers from ticker 1058 and consume them, delete them, and/or offer them to one or more other users. In some embodiments, a content creator or other user may pay a fee to have a digital asset featured on ticker 1058.

FIG. 10b depicts user interface 1000b, which may be similar user interface 1000a of FIG. 10a except that user interface 1000b may also include a tolerance slider 1060 for filtering incoming offers based upon relationship score. The offer screen may include a display of the current tolerance setting 1062 for receiving offers from other users. By tapping or otherwise selecting the current tolerance setting, tolerance slider 1060 may be displayed, which can allow the user to set the tolerance threshold of their offer inbox. When set, only offers from users with relationship scores equal to or higher than the threshold may be displayed on the user's offer screen. For example, if the tolerance threshold is set to ‘−1’, only users with a sender relationship of ‘−1’ or higher will be displayed on the user's offer screen.

In some embodiments, offers may only last for a predetermined period of time (e.g., three days). After the time expires, sender relationships with those who sent these expired offers may be decremented (e.g., receive a −1). In other embodiments, offers may last indefinitely and/or a sender of such an expired offer may not suffer a decrement in their relationship score with the user.

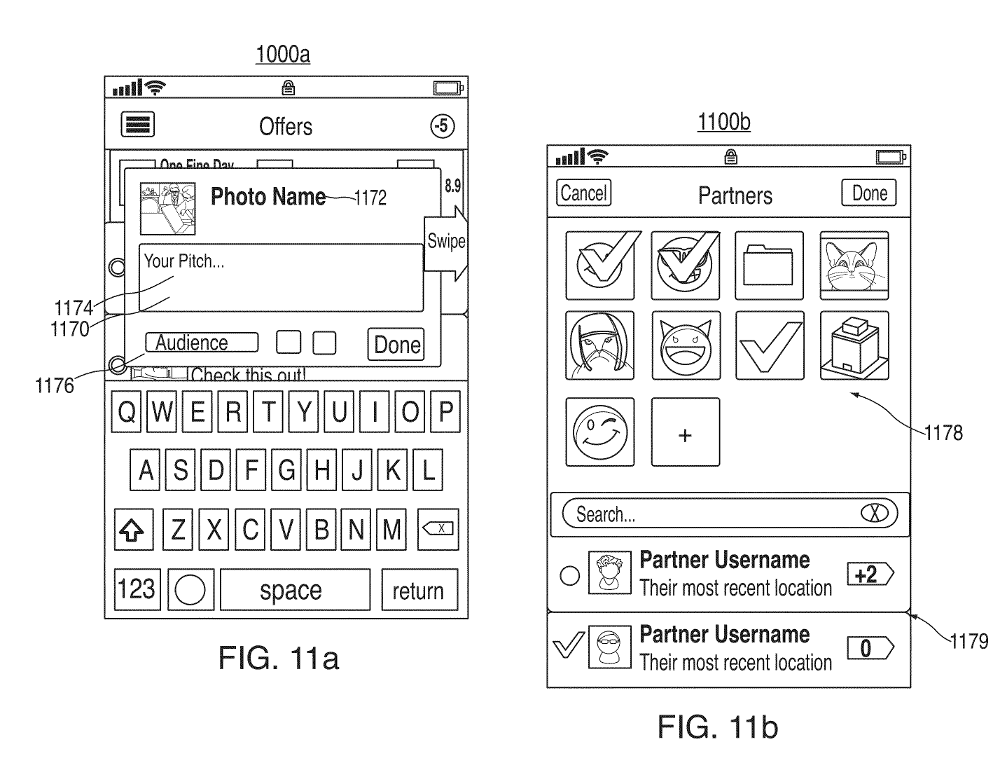

FIG. 11a depicts an illustrative user interface 1100a for distributing electronic digital assets in accordance with some embodiments. According to various embodiments, received offers may be sent on, or a user may generate and upload new content onto the system. In either case, the offer function may be similar or identical. As depicted in FIG. 11a, when a user decides to offer a particular digital asset, a form 1170 may be generated (e.g., using a pop-up) for the user to fill in information about the digital asset. For instance, the user may name the digital asset 1172 and/or define a “pitch” 1174 for the digital asset. As used herein, a pitch may be a short description of the digital asset and/or an explanation of why the user believes that the chosen recipients will enjoy the digital asset.

Next, and as shown in user interface 1100b of FIG. 11b, the user may choose individuals and/or groups to receive the offer by tapping or otherwise activating an audience button (e.g., audience button 1176 of FIG. 11a). Illustrative icons displayed on user interface 1000a may represent user-created groups 1178. Individuals 1179 may be represented by a picture, avatar, or other icon as defined in their own user profile.

Once the individuals and/or groups are chosen, the user can initiate the offer as shown in FIG. 11a. In some embodiments, a user can offer a digital asset by tapping or otherwise activating a button on user interface 1100a (e.g., “Done”) or by performing a gesture (e.g., swiping form 1170 to the right). Doing so may result in the offer being sent to the chosen recipients through the distribution system. A user may also choose to send and/or publicize the offer via one or more other social media platforms (e.g., Twitter or Facebook). The user may send or publicize the offer via such platforms by tapping or otherwise activating the appropriate icon on user interface 1100a.

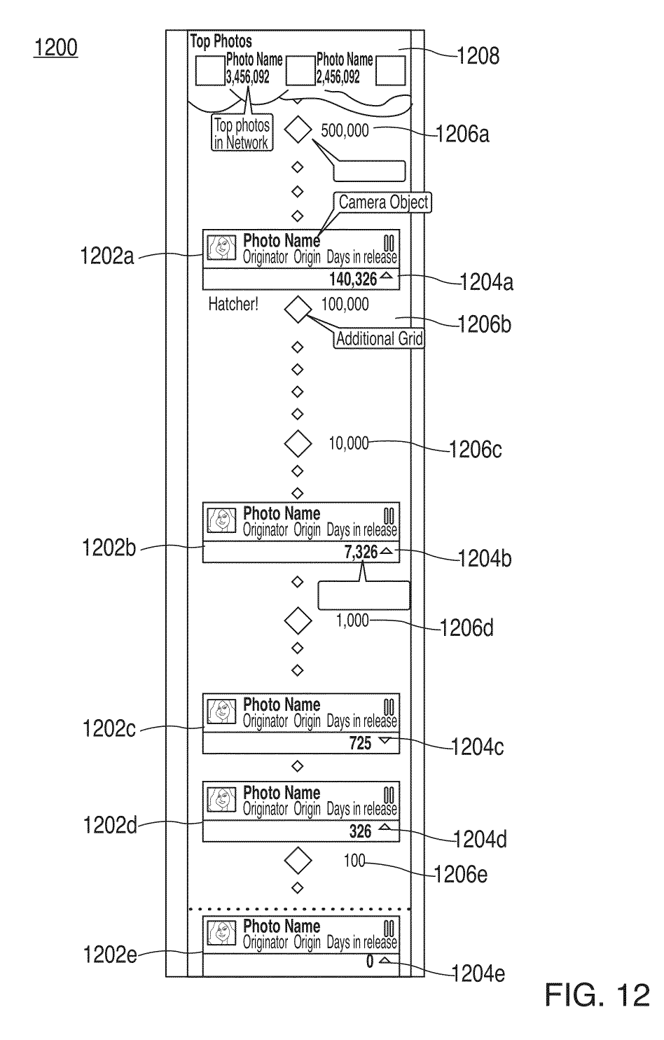

FIG. 12 depicts an illustrative user interface 1200 for viewing overall scores 1204a-1204e for digital assets 1202a-1202e in accordance with some embodiments. The overall score may correspond to the running audience score disclosed above. One or more digital assets 1202a-1202e, and the overall score 1204a-1204e for each digital asset, may be displayed on a ladder-like display. The ladder may display digital assets 1202a-1202e with higher scores further up the ladder along with different goal milestones 1206a-1206e. For example, a digital asset with an audience of 4.9 million when placed on an audience ladder would be placed just below the 5 million audience member goal. When the object reached an audience of 5 million the digital asset could move further up the ladder, passing and achieving the 5 million goal. In this example digital assets with smaller audience, (e.g., 1 million or zero) would be placed down lower on the ladder in descending order. User interface 1200 may also include ticker 1208, which may be similar or identical to ticker 1058 of FIG. 10.

Rewards may be given for completing one or more goals. For instance, if a digital asset or user achieves an objective an achievement badge or other award may be rewarded. Exemplary rewards may include:
1. Additional time (hours or minutes) that can be applied to any piece of content the user has launched;
2. Additional launches of new content;
3. Communication abilities—The awarded user can broadcast messages to his or her entire audience. Or a digital asset's entire audience;
4. New application functionality—The user may be granted additional functionality within their mobile app. For example, the user may be entitled to new audience visualizations, the ability to change their avatar (profile photo, or pin head on the map), and/or the ability to send offers to more than one user at a time. In some embodiments, the sharing could start out with limited functionality and as a user has more successful shares they are allowed to send out to more people at a time and/or see deeper into their audience; and
5. Content unlocks—User may be given the ability to unlock certain extra content that is associated with the original propagating content, including behind-the-scenes content, additional photos, additional songs, advertisements for other products, and/or other digital assets.

In some embodiments, rewards may be monetary. For example, the creator of a digital asset may wish to financially reward individual users for excellence in distribution. Excellence may be determined, for example, by reaching one or more goals as defined by the system (e.g., default objectives) or by meeting specific distribution criteria as determined by the creator. In one example, a creator may wish to financially reward a user for starting a new distribution branch in a geographically diverse location.

In some embodiments, the system can be a game, or include game-like features, that reward users for launching new digital assets and/or distributing pre-existing digital assets. For example, users can launch new content into the system and then grow their audience as the content successfully finds new members. Progress updates, content audience analytics, content unlocks, and important in-game decisions may all be displayed to the user. Including game features may create incentive for users to distribute digital assets throughout the system. Thus, the game may include a system of tasks and rewards. Each user can be a distributor within the system, and the more successful they are, the more highly ranked they may become in the community, and the more tools they may receive to enhance their distribution capabilities. Game features may apply to particular digital assets as well as individual users. For instance, each digital asset may be ranked according to certain metrics (distance traveled, audience size, speed of travel, etc.)

Specific examples of game-like features may include:
1. A content time limit. For example, propagating content could be given a time limit for action to be taken (e.g., if it's not acted upon within a day, then the user's branch of propagation dies);
2. Rewards. For example, a user could earn reward badges for completing game objectives. These badges could be cashed in for any suitable reward. In some embodiments, reward badges may be exchanged for extending a digital asset's objective time limit. Reward badges may also be exchanged between users;
3. Users can build up the ability to share. For instance, if a user has one successful share, they can receive the ability to send to 2 people at once and so on. Thus, individual users can create distribution groups that tend to enjoy the digital assets that the user is distributing;
4. Unlock new levels and objectives;
5. Users may be required to successfully complete a share in order to be given the ability to share more; and
6. Unlock functionality. For instance, a beginning user might not be able to see their content relationships, but when they achieve higher levels their relationships can be revealed, making it easier for them to distribute content to the right people.

Game features may include the completion of certain objectives for a particular digital asset. Examples of potential objectives may include:
1. Distance, where the user attempts to have the digital content travel a certain aggregate distance (e.g., 10,000 miles);
2. Audience, where the user attempts to have the digital content reach a certain audience size (e.g., 1,000,000 users);
3. Speed, where the user attempts to have the digital content achieve a certain speed (e.g., the number of miles it travels per second);
4. Transaction speed, where the user attempts to achieve a certain number of transactions per second;
5. Virality, which can measure how many new recipients each first-level recipient creates;
6. Specific locations, where the user attempts to get the digital content to arrive in certain locations, including continents, countries, cities, landmarks, etc.;
7. Specific people, where the user attempts to get the digital content to a specific person (e.g., a celebrity); and
8. Specific types of people, where the user attempts to get the digital content to a specific type of person. These specific types may include a node (someone who successfully offers the digital asset to more than a threshold number of new users), a loner (someone who is geographically distant from the initial audience), a spark (someone who begins a successful distribution branch in a geographically new area), a broadcaster (someone who sends out a large number of offers), or a diehard (someone who continues to support a digital asset for a long time).

In some embodiments, objectives may be collaborative. For example, the entire audience for a particular digital asset could be rewarded when the content reaches certain objectives. In other embodiments, audience members could challenge each other to see who could reach a particular objective first.

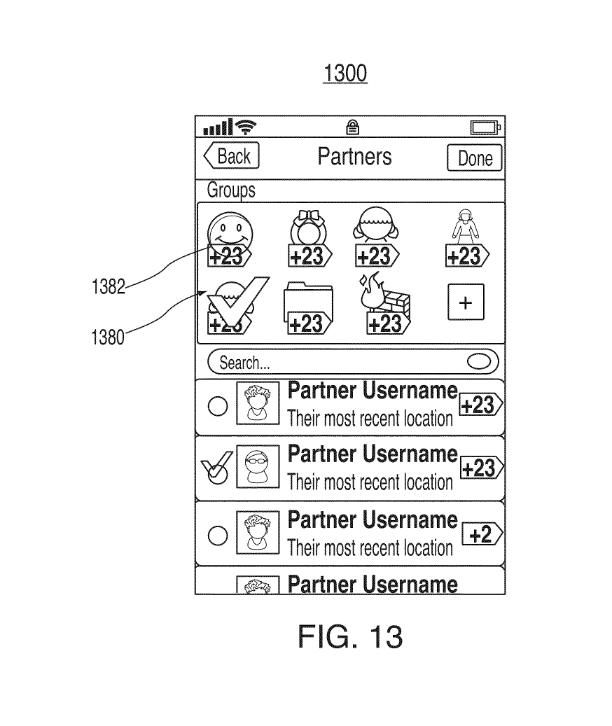

FIG. 13 depicts illustrative user interface 1300 for viewing and choosing partners for the distribution of digital assets in accordance with some embodiments. User interface 1300 may represent a simple and straightforward way to create segmented groups of potential recipients of digital assets. For example, a user may create designated groups of recipients to receive funny content, photos of cats, sports content, grunge music, or any other suitable digital asset category. Individual groups may be listed in groups section 1380 of user interface 1300.

According to some embodiments, one or more groups in groups section 1380 may be auto-generated for a first-time user based on the digital asset offered. For example, a user could choose an audience for a specific image and the system could create a group with the name of the photo, or the tag associated with the photo, for easy sharing next time. In some embodiments, the system may determine the content of the offered digital asset and attempt to categorize the group based on the digital asset. In some embodiments, a set of default placeholder groups may be made available for the user to populate and modify as desired.

Using groups to distribute digital assets, a user can segment his or her audience and get feedback (via an overall group-relationship score) on how well he or she is pleasing that audience. An index of a group's overall “happiness” (e.g., the average or total of the relationship scores within the group) can be tracked. The happiness index 1382 may be presented in user interface 1300 by increasing or decreasing the size of a graphic that represents that group and/or by displaying an index value. The index value may be similar to the relationship score disclosed above except that it aggregates the user's relationship score with each member of the group for digital assets offered specifically to that group.

In additional embodiments, a group score may be tracked for each individual digital asset shared with that group. For example, a digital asset happiness score can track how positively the group reacted to a particular digital asset by counting and/or comparing the number of positive and negative reactions of users in the group

The user may also view the relationship scores of individual members of each group. In some embodiments, a relationship score may be established for each partner based on their membership in a particular group as well as the partner's overall relationship score. For instance, if a particular partner was a member of a funny content group and a photos of cats group, a relationship score may be established that tracks the partner's actions with respect to each group individually in addition to an overall relationship score.

In some embodiments, the system may analyze the downstream audience and suggest potential new users for initial distributions of certain content. As one example, if a particular recipient is in the downstream audience of a certain percentage of a sender's offers (e.g., a percentage that exceeds a pre-determined threshold), the sender may be given that recipient's identification information so that future digital assets can be offered directly from the sender to the downstream recipient.

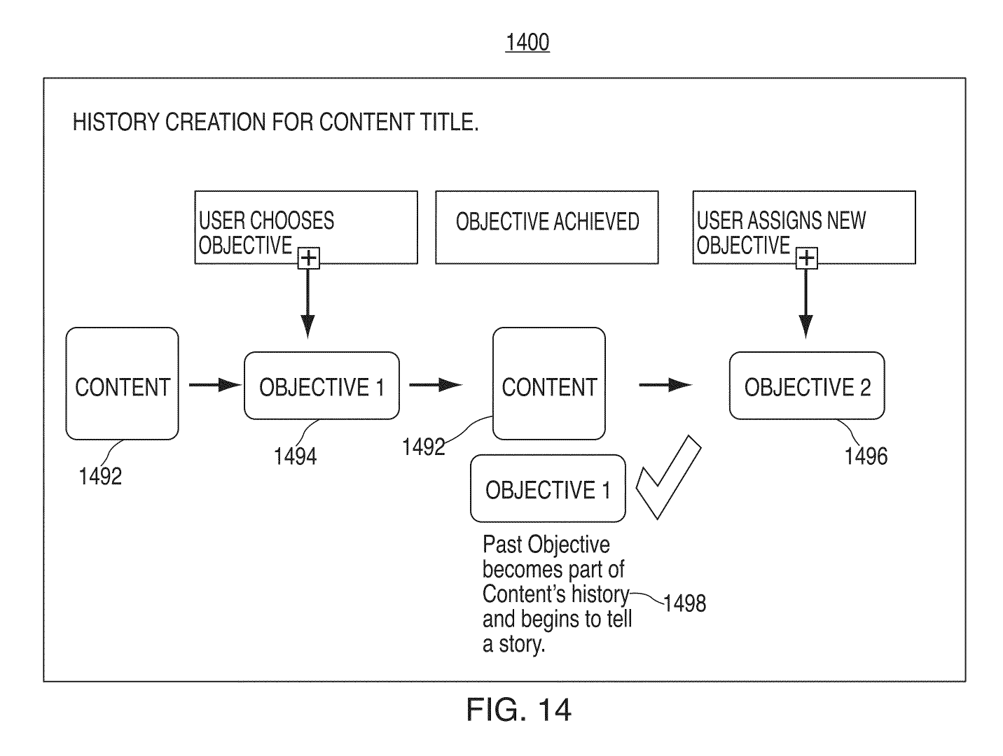

FIG. 14 is a diagram depicting an illustrative system 1400 for creating a digital character out of a digital asset 1492 in accordance with various embodiments. By giving digital asset 1492 a goal (e.g., audience size, location, etc.) and an obstacle 1494 (e.g., limited time, a competitor, etc.) the system could create a character out of digital asset 1492 and generate a history 1498 for the digital asset.

Therefore, to create an emotional attachment to the content, each digital asset 1492 may obtain a digital character. For instance, a user may choose an objective 1494 for the content that must be reached in spite of an obstacle (e.g. a time limit). An obstacle could be any of a number of barriers the content title must overcome to pass on to the next level. As the content propagates to its audience and completes various new objectives (e.g., objective 1496) it can generate history 1498. History 1498 can be unique for each digital asset and gives that digital asset its own unique character. One digital asset could develop a history of meeting its objectives at the last possible moment. Another could have had great difficulty in Russia but then catch fire and become very popular when it reached Texas. Rather than a two dimensional copy of the content where everyone's experience of the content is the same, the invention can allow the user to get to know the content's unique story and become a part of creating it.

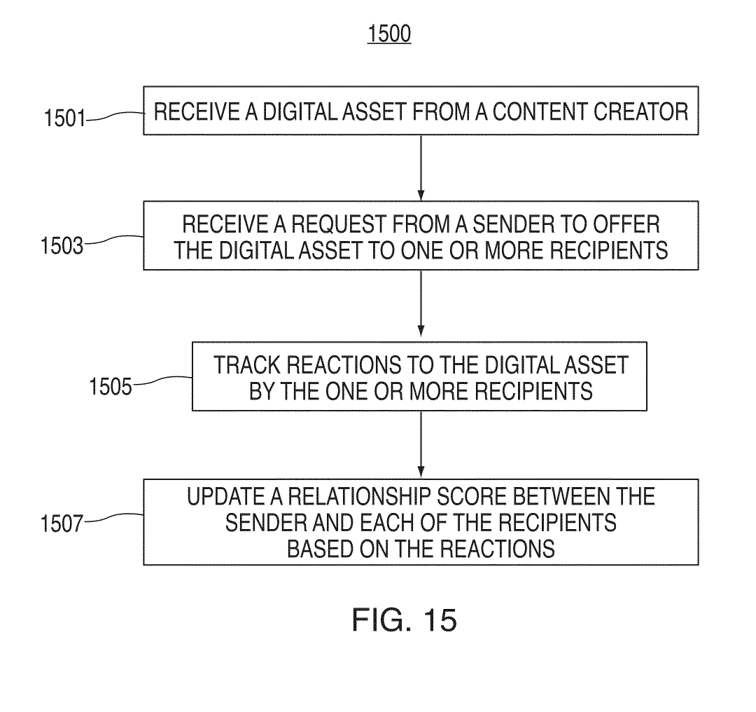

FIG. 15 is a flowchart of an illustrative process 1500 for tracking the propagation of a digital asset in accordance with some embodiments. At step 1501, a server (e.g., server 630 of FIG. 6) can receive a digital asset from a content creator. The content creator may be the user (e.g., a photographer, a film maker, a musician, a songwriter, a distributor, a marketer, or a writer) who originally introduces the digital asset to a distribution system (e.g., system 600 of FIG. 6) that in includes the server.

The digital asset can be any suitable electronic file including, but not limited to: a written work, such as an article, a book, a scholarly paper, a poem, a status update, or a short message; a video file, such as a video clip, a music video, a full-length film, a short film, a teaser, or a commercial; an audio file, such as a song, an album, a podcast, a lecture, a or commercial; an image, such as a photograph, a computer-generated image, a digital reproduction of artwork, or an icon; a mixed-media file, such as an advertisement, promotional materials for an event, or an invitation; or a non-media file, such as computer executable code.

At step 1503, the server can receive a request from a sender to offer the digital asset to one or more recipients in a distribution web (e.g., distribution web 200 of FIG. 2). The sender (e.g., sender 102 of FIG. 1) may be the content creator or any other user of the network with access to the digital asset, such as a downstream recipient of the digital asset (e.g., recipient 106 of FIG. 1) from the content creator.

At step 1505, the server can track reactions to the digital asset by the one or more users. That is, once the offer is made, the one or more recipients of the distribution web may be permitted to access and react to the digital asset. Potential reactions may include consuming the digital asset, deleting the digital asset, ignoring the digital asset, or re-offering the digital asset to one or more other users of the distribution web.

At step 1507, the server can update a relationship score between the sender and each one of the one or more recipients based on the reactions. If a recipient reacts positively to the offered digital asset, by offering the digital asset to another user of the distribution web, for example, the relationship score between that recipient and the sender may be incremented. On the other hand, if the recipient reacts negatively to the offered digital asset, by deleting or the offered digital asset, for example, the relationship score between that recipient and the sender may be decremented.

Neutral reactions to an offered digital asset (e.g., consuming the digital asset without re-offering the digital asset or ignoring the digital asset) may result in no change or a decrement to the relationship score between the sender and the recipient. Whether the relationship score remains unchanged or is negatively impacted by a neutral reaction may be left up to each particular user of the distribution web or may be permanently defined by software residing on the server.

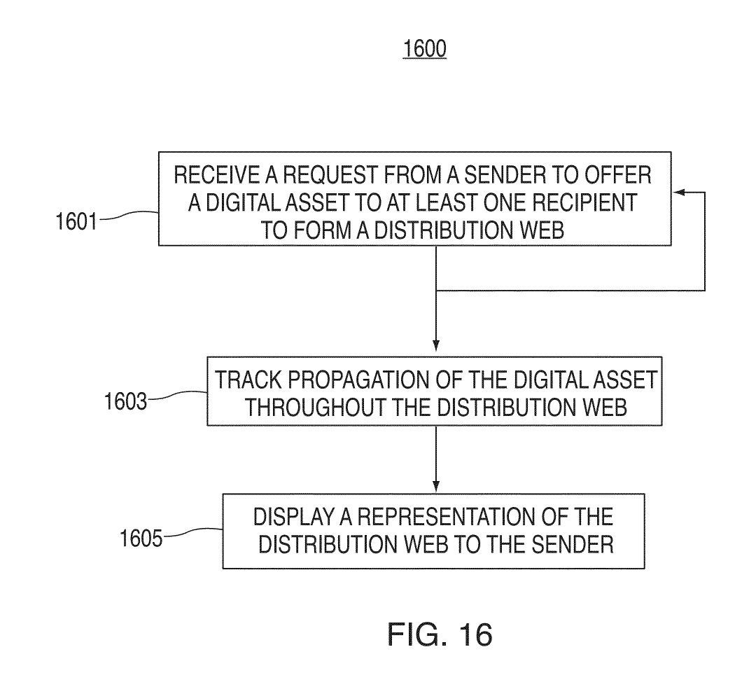

FIG. 16 is a flowchart of an illustrative process 1600 for tracking the propagation of a digital asset in accordance with some embodiments. At step 1601, a server (e.g., server 630 of FIG. 6) can receive a request from a sender (e.g., User 1 of FIG. 2) to offer a digital asset (e.g., recipient 104 of FIG. 1) to at least one recipient (e.g., Users 2 and 3 of FIG. 2) to form a distribution web (e.g., distribution web 200 of FIG. 2).

In some embodiments, step 1601 can loop indefinitely, whereby each recipient of an offer from the sender can become a sender and subsequently offer the digital asset to at least one further recipient in the distribution web. For example, in the second iteration of step 1601,

User 202 and User 203 of distribution web 200 can offer the digital asset to User 204 and Users 205 and 206, respectively.

According to some embodiments, step 1601 may stop looping under a number of circumstances. For example, a content creator may set an expiration date for the digital asset, after which access to the digital asset may be blocked, further offers of the digital asset may be blocked, and/or the digital asset may be removed from the server. As another example, the digital asset may have a distribution audience of a fixed size, such that once the digital asset has reached a threshold audience size, no further offers of the digital asset may be made. As still one more example, the content creator, or other suitable user, may delete the digital asset from the server (e.g., after a predetermined period of time or in response to a Digital Millennium Copyright Act (“DMCA”) takedown request).

At step 1603, the server can track propagation of the digital asset throughout the distribution web. Propagation of the digital asset may be tracked continuously while step 1601 loops and the distribution web increases in size. Tracking the propagation of the digital asset may involve harvesting user data (e.g., user name, pseudonym, geographical location, etc.) at each hop of the digital asset.

At step 1605, the server can display a representation of the distribution web to the sender. The distribution web may be displayed to any sender in any suitable manner. As one example, a list of senders' identities (e.g., names, pseudonyms, user profiles, etc.) can be provided to a sender. Accordingly, such a sender can view a list of users in the distribution web who reacted positively the digital asset (i.e., by re-offering the digital asset). As another example, the distribution web may be displayed in graphical format such as distribution web 200 of FIG. 2. As still another example, the distribution web may be displayed on a map (e.g., distribution maps 300a-300c and/or distribution maps 400a-400c of FIGS. 3a-3c and 4a-4c, respectively).

In any display scheme, the sender may be able to view how the digital asset propagated over time, by using a slider (e.g., slider 302 of FIG. 3a), for example. As yet one more example, the distribution web, or a part thereof may be represented as a running audience score (e.g., running audience score 304 of FIG. 3). The running audience score may represent the entire audience for a digital asset in the distribution web and/or an individual running audience score for a particular sender in the distribution web.

In some embodiments, a sender may only be permitted to view the path(s) of the distribution web of which that sender is member. For example, a sender may be permitted to view the upstream path of the digital asset prior to the sender receiving the digital asset and/or the downstream path(s) of recipients whose offers can ultimately be traced back to the sender.

In other embodiments, a sender may be permitted to view the entire distribution web. In these embodiments, recipients downstream of the sender may be represented differently from other users in the distribution web to allow the sender to gauge his/her user impact on the distribution web as a whole.

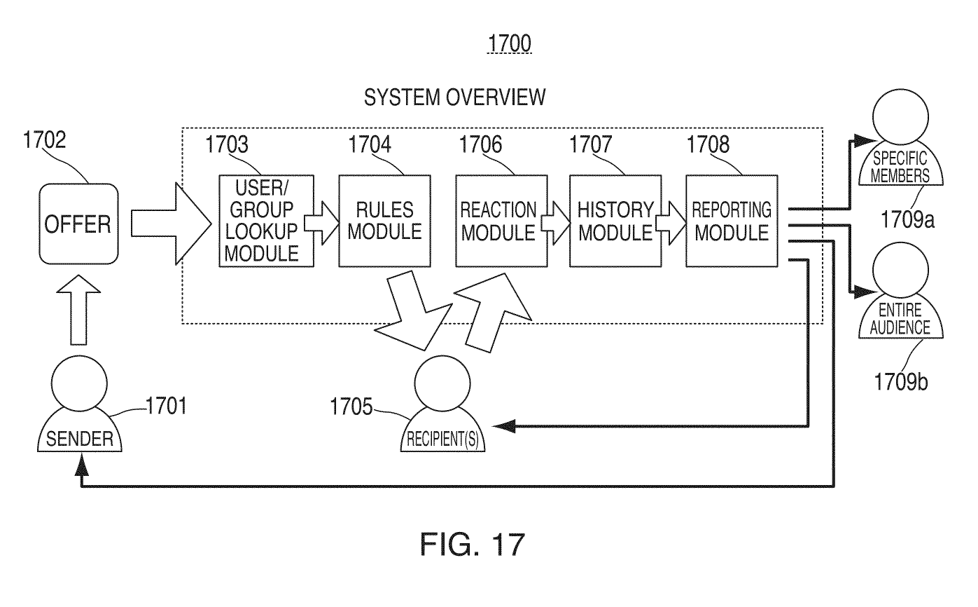

FIG. 17 is an illustrative system 1700 for distributing and tracking digital assets in accordance with various embodiments. In particular, system 1700 can illustrate how an offer 1702 can propagate through an exemplary system sharing and tracking system. System 1700 can include a user lookup module 1703, a rules module 1704, a reaction module 1706, a history module 1707, and a reporting module 1708.

A sender 1701 can create an offer 1702 for a digital asset from their electronic device. Offer 1702 can then enter user lookup module 1703, which can determine which users are intended recipients of offer 1702 from sender 1701. The intended recipients may include individual partners and/or groups as described above with respect to FIG. 13. If offer 1702 is a “public offer” in which a recipient pulled the offer from a website or physical location, user lookup module 1703 may be bypassed as sender 1701 may not know the intended recipient in advance.

A listing of intended recipients may then passed to rules module 1704 where it can be determined, based on the respective intended recipients' relationship scores, for example, whether that offer will be delivered to each recipient. For instance, sender 1701 may be permitted to send offer 1702 intended recipients with acceptable relationship scores. Sender may not be permitted to send offer 1702 to intended recipients with relationship scores below a certain relationship-score threshold. Recipients 1705 may be intended recipients who may be permitted to receive offer 1702 based on the determination of rules module 1704.

Recipients 1705 can each then choose to act on the offer 1702 or not. This respective choices can be passed back to the reaction module 1706 in which the relationship scores between sender 1701 and each of recipients 1705 can updated to reflect each recipient's decision. For instance, the relationship scores for recipients 1705 who reacted positively to offer 1702 can be incremented while the relationship scores for recipients 1705 who reacted negatively to offer 1702 can be decremented.

The digital asset associated with offer 172 can then be passed to history module 1707 in which its “history,” including, for example, users' reactions to offers for the digital asset, can be updated to reflect the choices passed to reaction module 1706. History module 1707 can recalculate the analytics for the particular digital asset. These analytics could include any of a number of calculations including, but not limited to, the total audience size, a specific user's audience size, objectives reached, rewards reached, new locations, milestones, audiences within a specific locale.

This updated history can then be passed to reporting module 1708. Reporting module 1708 can determine what should be displayed to the audience for the digital asset. This could include but is not limited to points on a map, notifications (e.g., mobile, email, or SMS notifications) of milestones passed, specific user rewards, entire audience rewards, data visualizations, money paid to the originator, money paid to other users, individual user impact on the digital asset, users currently supporting the digital asset. These reports can be directed at the entire audience 1709b or a subset of the audience 1709a as well as recipients 1705 and sender 1701.

While there have been described systems and methods for tracking the propagation of digital assets, it is to be understood that many changes may be made therein without departing from the spirit and scope of the invention. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The described embodiments of the invention are presented for the purpose of illustration and not of limitation.

What is claimed is:

1. A system for tracking the propagation of digital assets, the system comprising:
a server for storing a plurality of digital assets; and
an electronic device configured to access the server, wherein the electronic device is further configured to:
access a digital asset from the plurality of digital assets stored on the server;
offer the digital asset to one or more recipients with access to the server; and
receive a reaction from each recipient of the one or more recipients.

2. The system of claim 1, wherein the reaction received from a recipient of the one or more recipients comprises data about whether the recipient took one of a positive, a negative, and a neutral action with respect to the digital asset.

3. The system of claim 2, wherein the electronic device comprises a display, and wherein a graphical representation of at least one reaction is shown on the display.

4. The system of claim 3, wherein the graphical representation further shows a reaction of at least one other user of the system in addition to the one or more recipients.

5. The system of claim 1, wherein the server comprises a cloud storage unit.

6. The system of claim 1, wherein the electronic device comprises one of: a smartphone; a TV; and a PC.

7. The system of claim 1, wherein the digital asset comprises one of: a written work; a video file; an audio file; an image (e.g., a photograph, a computer-generated image; a mixed-media file; and computer executable code.

8. A method for tracking the propagation of digital assets within a distribution web, the method comprising:
receiving, at a server, a request from a sender to offer a digital asset to at least one recipient, the sender and recipient forming the distribution web, wherein receiving continues to occur until a predetermined event occurs;
tracking propagation of the digital asset throughout the distribution web; and
displaying a representation of the distribution web to the sender.

9. The method of claim 8, further comprising noting that a predetermined event occurred that interrupts receiving.

10. The method of claim 8, further comprising determining a downstream audience of the sender, the downstream audience comprising recipients become a sender and offer the digital asset to further recipients while the receiving continues to occur.

11. The method of claim 10, further comprising determining a physical location associated with each recipient of the downstream audience.

12. The method of claim 11, wherein the displaying comprises generating and displaying a distribution map comprising a representation of each of the physical locations.

13. The method of claim 12, wherein the displaying further comprises generating and displaying a graphical representation of the digital asset propagating through the distribution web as a function of time.

14. The method of claim 12, wherein the displaying further comprises generating and displaying a distribution map comprising a representation of physical locations of additional recipients not in the downstream audience of the sender.

15. The method of claim 8, wherein the displaying comprises listing each user of the distribution web who offered the digital asset to at least one recipient.

16. A method for tracking the propagation of digital assets, the method comprising:
receiving, at a server, a digital asset from a content creator;
receiving a request from a sender to offer the digital asset to one or more recipients;
tracking reactions to the digital asset by the one or more recipients; and
updating a relationship score between the sender and each of the one or more recipients based on the reactions.

17. The method of claim 16, wherein the reactions comprise at least one of: a positive reaction; a negative reaction; and a neutral reaction.

18. The method of claim 17, wherein the relationship score is incremented in response to a positive reaction and decremented in response to a negative reaction.

19. The method of claim 17, further comprising determining a user impact for the sender, wherein the user impact comprises at least one of:
a list of users in a downstream audience of the sender;
a number of positive reactions from the one or more recipients;
an aggregate amount of time that the users of the downstream audience have been supporting the digital asset; and
a number of users of the downstream audience who are currently supporting the digital asset.

20. The method of claim 16, further comprising blocking received requests from the sender to one or more recipients who have respective relationship scores with the sender below a predetermined threshold.
